(19) United States
(12) Patent Application Publication
(10) Pub. No.: US 2009/0029250 A1
(43) Pub. Date: Jan. 29, 2009

(54) Polymer Electrolyte The Use Thereof And An Electrochemical Device Containing Said Polymer Electrolyte

(75) Inventors: Jurgen Stebani, Kaufburen (DE); Robert Gartner, Germaringen (DE); Gerhard Maier, Munchen (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: POLYMATERIALS AG, Kaufbeuren (DE)

(21) Appl. No.: 11/909,531

(22) PCT Filed: Mar. 23, 2006
(86) PCT No.: PCT/EP2006/002691

§ 371 Date: May 22, 2008

(30) Foreign Application Priority Data
Mar. 24, 2005 (DE) 10 2005 013 790.3

(51) Int. Cl. H01M 6/00; H01M 10/00

(52) U.S. Cl. 429/199; 429/188

(57) ABSTRACT

The present invention relates to a polymer electrolyte having a lithium salt component and a polymer component, wherein the polymer component comprises at least one polymer compound, the repetitive units of which have at least partially groups which interact with the anions of the lithium salt component such that the dissociation of the lithium salt is enhanced. Thereby, a high ion conductivity of the polymer electrolyte is ensured by the interaction of the polymer component with the anions of the lithium salt component without a liquid component, i.e. without plasticizer and solvent. The polymer electrolyte according to the present invention is particularly suitable for the use in an electrochemical device, in particular in a battery and a secondary battery. Furthermore, the present invention relates to the use of the polymer electrolyte for producing an electrochemical device, in particular a battery and a secondary battery, an electrochemical device comprising the polymer electrolyte as well as a method for increasing the ion conductivity of polymer electrolytes.

The present invention relates to a polymer electrolyte having a lithium salt component and a polymer component, wherein the polymer component comprises at least one polymer compound, the repetitive units of which have at least partially groups which interact with the anions of the lithium salt component such that the dissociation of the lithium salt is enhanced. This provides for a high ion conductivity of the polymer electrolytes due to interaction of the polymer component with the anions contained in the lithium salt component without liquid component, i.e. without plasticizer and solvent. The polymer electrolyte according to the present invention is particularly suitable for the use in an electrochemical device, in particular in a battery and a secondary battery. Moreover, the present invention relates to the use of the polymer electrolyte for preparing an electrochemical device, in particular a battery and a secondary battery, an electrochemical device comprising the polymer electrolyte as well as a method for increasing the ion conductivity of polymer electrolytes.

Lithium metal polymer batteries, lithium polymer batteries and lithium ion batteries are electrochemical devices which essentially consist of an anode, an electrolyte conducting Li ions and a cathode. The material of the anode may be lithium metal or a material which intercalates lithium atoms. The electrolyte may be a liquid, a gel or a solid polymer. The cathode consists of a material which is capable of intercalating lithium ions, thereby simultaneously reducing the material. Such devices serve to reversibly store electrical energy. Therefore, such devices should actually be referred to as “secondary batteries”. Thus, secondary batteries are capable of passing through a large number of charge-discharge-cycles. In contrast, a battery cannot be recharged after being discharged. Nevertheless, the term “batteries” for lithium metal polymer batteries, lithium polymer batteries and lithium ion batteries has become established in day-to-day language use. According to the present state of the art, lithium ion batteries which are intended to be operated at room temperature, must have a liquid or viscous electrolyte because only such electrolytes have a sufficiently high conductivity for Li ions. If the conductivity of the electrolyte is too low, these batteries are not suitable for most applications inter alia because they allow for too low discharge currents only.

Due to the high reactivity of elemental lithium (as metal or as an intercalation compound of lithium atoms) as compared to organic compounds, in particular polar solvents, a problem results in that batteries containing lithium ions must not be exposed to high temperatures and, in particular, must not be overcharged or charged with too high change currents because a decomposition reaction of the electrolyte may occur under such circumstances. This decomposition reaction is exothermic and in case of liquid electrolytes or electrolytes containing liquids for example as plasticizers, the decomposition reaction often leads to gaseous decomposition products and, thus, to a drastic pressure increase within the battery which may result in the destruction or even in the explosion of the battery in case of an improper operation.

In case of lithium polymer batteries and lithium metal polymer batteries containing polymers as electrolytes, this security problem is attempted to be solved. However, at room temperature such electrolytes exhibit significantly lower conductivities for Li ions (up to several orders of magnitude) than liquid electrolytes or gel electrolytes. For example, the conductivities of standard systems on the basis of poly(ethylene oxide) doped with various lithium salts are typically below 10⁻⁶ S/cm at room temperature. This low conductivity is primarily attributed to the partial crystallinity of poly(ethylene oxide) and other polyethers employed for this application at room temperature, thereby severely reducing the charge carrier mobility. Therefore, liquid solvents or plasticizers are admixed to polymer electrolytes or gel electrolytes in order to improve the conductivity. Thereby, conductivities of more than 10⁻⁴ S/cm can be achieved. However, similar problems as with liquid electrolytes occur because also the solvents and plasticizers may form gaseous decomposition products. Alternatively, batteries with polymer electrolytes may also be employed at higher temperatures in order to achieve a higher conductivity. For this purpose, a range around 65° C. is frequently selected as the operation temperature. This means, however, a loss in capacity and power density of the battery, respectively, because a part of the stored electric energy must be used for the temperature increase. Moreover, the complexity and thereby the price of the battery is significantly increased because a heating system, a temperature control system as well as safety means for shutting down the heating system are required because also the polymer electrolytes start to decompose upon contact with elemental lithium at too high temperatures.

According to the current state of the art, polymer electrolytes conducting Li ions contain an Li salt to facilitate the ion conductivity. Thus, the ion conductivity essentially depends on the number of ions, i.e. the degree of dissociation of the salt, as well as on the mobility of these ions. However, a higher concentration of the Li salt improves the conductivity by increasing the ion concentration only if the salt is present in a dissociated state at the increased ion concentration. However, this improvement of the conductivity is possible to a certain degree only, because at higher salt concentrations an increasing amount of associates of several lithium ions occurs. In consequence, the number of ions and, thus, that of the charge carriers does not increase any more. Furthermore, the lithium salts represent one of the most expensive constituents of such polymer electrolytes and, thus, it is desired to use lithium salts in the lowest possible concentrations.

Therefore, there is considerable interest in new polymer electrolytes for lithium ion batteries, lithium polymer batteries and lithium metal polymer batteries which consist of a polymer which is solid at room temperature (i.e. at about 25° C.), which do not contain any liquid constituents and which nevertheless exhibit high Li ion conductivities (>10⁻⁴ S/cm) at room temperature at as low a content of Li salts as possible.

In order to improve the Li ion conductivity substantially two approaches are pursued in the art. One approach is to increase the number of charge carriers by means which ensure a complete dissociation of the Li salt, and the other approach is to increase the mobility of the Li ions.

The dissociation of the salts is achieved for example by employing polar polymers containing groups which are capable of solvating Li ions, thereby promoting the dissociation. Alternatively, also unpolar polymers may be employed, wherein polar additives have to be added which serve to solvate the Li ions.

The mobility of the Li ions is increased by employing plasticizers which lower the glass transition temperature of the polymers, thereby increasing the mobility of the polymer chains and, thus, also that of the Li ions. The amount of the plasticizers may become so high that the polymer represents a minor component in the polymer electrolyte only (so-called gel electrolytes). Alternatively, also low melting salts in connection with a polymer may be used as a polymer electrolyte for ensuring a minimum of mechanical properties and for the form stability of the polymer electrolyte.

However, these measures are not well suited in order to achieve high conductivities in a solid electrolyte. The term “solid electrolyte” as used herein is intended to designate an electrolyte which is solid at room temperature, i.e. an electrolyte, the softening temperature (glass transition temperature and melting temperature) of which is above 25° C.

The main disadvantage in using polymers or additives capable of solvating Li ions is that the salt dissociation is indeed supported by the interactions between the Li ions and these polymers or additives and the Li ions are released, but at the same time the Li ions are retained to some extent, thereby lowering their mobility. Thus, the number of charge carriers is actually increased, but the conductivity is increased to a relatively low extent only because the Li ions are less mobile. The approach of increasing this mobility by adding plasticizers or solvents in turn leads away from the object of producing a solid electrolyte without a content of liquids.

A further problem of Li ion batteries, Li polymer batteries and Li metal polymer batteries according to the state of the art is the danger of deposition of lithium at the anode in the form of dentrites during the charging process, which may result in a reduced durability (number of charge and discharge cycles). Polymer electrolytes and gel electrolytes with plasticizers or solvents according to the state of the art exhibit glass transition temperatures below room temperature, i.e. they are soft at the operation temperature of the batteries, and, thus, they can not prevent the formation of dentrites. In contrast, solid polymer electrolytes having a softening temperature above the operation temperature are able to antagonize the formation of dentrites due to their stiffness.

Therefore, it is the object underlying the present invention to provide polymer electrolytes without liquid component, i.e. without plasticizer and solvent, which are solid at room temperature, which exhibit high ion conductivities at room temperatures and which further antagonize the formation of dentrites. Moreover, these polymer electrolytes should be suitable for use in electrochemical devices such as batteries and secondary batteries, in particular in lithium metal polymer batteries, lithium polymer batteries and lithium ion batteries, and they should have a glass transition temperature above room temperature. The electrochemical devices obtained therewith shall become more stable and safe by using these polymer electrolytes.

Upon testing polymer compounds for polymer electrolytes it has now been found that the increase in the conductivity of the polymer electrolytes can also be effected by promoting the dissociation of the Li salt not conventionally by interaction of the polymer with the Li ions, but by interaction of the polymer with the counter ions (anions) of the Li salt. This fundamental new approach not only facilitates the dissociation of the salt, but simultaneously causes also an improved mobility of the Li ions compared to conventional polymer electrolytes, because in contrast to conventional polymer electrolytes the Li ions are thereby actually released from the salt, whereas due to the interaction with the polymer, the anion exhibits a reduced mobility only. In contrast, in the case of conventional polymer electrolytes, the mobility of the Li ion is constrained by its interaction with polar polymers or additives (mostly with ether groups, ester groups or carbonate groups), whereas the anion is released. The interaction of the polymer with the anions of the Li salt can be achieved by introducing positive charges via suitable functional groups into or at a polymer chain.

Therefore, the object underlying the present invention is solved by the polymer electrolyte according to any one of claims 1 to 17, the use of the polymer electrolyte according to any one of claims 18 to 20, the electrochemical device according to any one of claims 21 to 23 and the method according to any one of claims 24 to 26.

According to the present invention, the object underlying the present invention is solved by a polymer electrolyte comprising a lithium salt component and a polymer component, wherein the polymer component comprises at least one polymer compound, the repetitive units of which have at least partially groups which interact with the anions of the lithium salt component such that the dissociation of the lithium salt is enhanced, wherein these groups are an element of the polymer main chain and/or an element of side chains of the polymer compound attached to the polymer main chain.

Preferably, the groups enhancing the dissociation of the lithium salt are cationic groups.

In a preferred embodiment the polymer electrolytes according to the present invention comprises a lithium salt component and a polymer component comprising at least one polymer compound, the repetitive units of which have at least partially cationic groups, wherein the cationic groups are an element of the polymer main chain and/or an element of side chains of the polymer compound attached to the polymer main chain.

The polymers used in the polymer component may be homopolymers or statistic polymers, alternating copolymers, block copolymers or graft copolymers, the cationic groups can be bonded to the polymer main chain directly or via a bridging group as substituents or to side chains (e.g. in graft copolymers) or they can also be an element of the main chain or graft branches.

Polymer compounds suitable for the use in the polymer electrolytes according to the present invention as well as their synthesis are known in the art and described for example in E. A. Bekturov, Z. Kh. Bakauova: “Synthetic Water-Soluble Polymers in Solution”, Huethig & Wepf, Basel 1986; M. Tricot, F. Debeauvais, C. Houssier, Eur. Polym. J. 11, 589 (1975), Y. Chang et al., Macromolecules 27, 2145 (1994) and U.S. Pat. No. 2,487,829.

The use of oligomers and polymers having cationic terminal groups as additives in polymer electrolytes for Li batteries is described in U.S. Pat. No. 6,803,152. However, the polymers described therein contain ether groups and, thus, the resulting electrolytes achieve high conductivities only by adding a plasticizer or a solvent (propylene carbonate). The object underlying the present invention cannot be achieved with the electrolytes according to U.S. Pat. No. 6,803,152.

The polymer electrolytes according to the present invention surprisingly achieve their high conductivities also in the absence of plasticizers, solvents and similar additives, even if they are constructed such that their glass transition temperatures are much higher than room temperature (up to more than 100° C.). Thereby, the undesired deposition of Li metal in the form of dentrites upon recharging the battery can be reduced.

Therefore, the use of the polymer electrolytes according to the present invention for Li ion batteries, Li polymer batteries and Li metal polymer batteries leads to three possible, technically and economically important advantages:
(i) the higher conductivity of the polymer electrolyte enables higher discharge currents;
(ii) the higher conductivity at room temperature enables lower operation temperatures leading to a reduction in the complexity of the system and to a wider application range because depending on the application no heating system is required; and
(iii) the high possible glass transition temperature reduces the formation of dentrites during recharging the battery, thereby increasing the durability (possible number of charge-discharge-cycles).

According to the present invention all polymers are suitable, which contain groups with positive charges in the repetitive units, such as for example, polymers containing ammonium groups, phosphonium groups, sulfonium groups or iodonium groups Polymers containing ammonium groups are particularly suitable. The cationic groups may be an element of the polymer main chain or of the polymer side chains. They may be contained in each repetitive unit or in lower proportions as well, such as for example in copolymers containing repetitive units with cationic groups and repetitive units without cationic groups.

The polymer main chains may be polymers such as polystyrene, polyacrylates, polymethacrylates, polyolefines, polyvinyl compounds, polyethers such as polyepichlorhydrin, poly(tetrahydrofuran), polydienes and the like, polycondensates such as polyesters, polyamides, polyimides, poly(aryletherketone)s, poly(arylethersulfone)s, poly(arylene oxide)s, polyarylenes, polycarbonates, polyanhydrides, polyurethanes, polyureas and the like, binary, ternary, quaternary and higher copolymers of such polymers, blends of at least two of these polymers, branched, hyper-branched and crosslinked polymers with such repetitive units.

According to the present invention, also microphase separated materials of such polymers may be used as the polymer component, wherein the cationic groups have to be present in at least one of the separated microphases. As used herein, the term “microphase separated materials” is intended to refer to compatibilized blends as well as block copolymers and graft copolymers of at least two of the above-mentioned polymers.

The molecular weight and the molecular weight distribution of the polymer compounds used according to the present invention is selected such that the glass transition temperature or the glass transition range of the resulting polymer electrolyte is above room temperature. The molecular weights and the molecular weight distributions which are required for this purpose, can easily be determined by the person skilled in the art.

Linear, cyclic and branched aliphatic, aromatic and aromatic-aliphatic ammonium groups, hydrazinium groups, phosphonium groups, sulfonium groups, iodonium groups and positively charged metal complexes and the like can be used as cationic groups, with linear, cyclic or branched aliphatic, aromatic-aliphatic and aromatic ammonium groups or analogously constructed phosphonium groups being preferred. Such ammonium groups are particularly preferred.

Further preferred cationic groups are selected from the following:

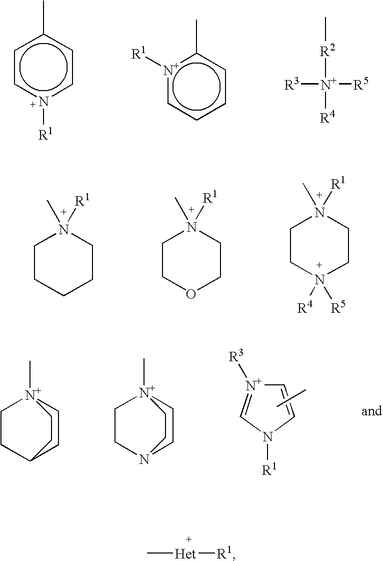

wherein
R¹, R³, R⁴, R⁵ independently represent optionally substituted alkyl, branched alkyl, cycloalkyl, vinyl, allyl, benzyl, aryl, heteroaryl or alkaryl groups,
R² is a single bond or an optionally substituted bifunctional alkyl, aryl, heteroaryl or alkaryl group which may optionally further contain one or more heteroatom containing group, for example ester groups, ether groups, amide groups, urea groups, urethane groups, carbonate groups, anhydride groups, imide groups and the like, and Het is a nitrogen containing, optionally substituted aromatic or non-aromatic heterocycle having one or more nitrogen atoms. Furthermore, the heterocycle preferably contains 2 to 15 carbon atoms. Pyridine, pyrazine, pyrazole, triazole, pyrrole, oxazoline, pyrrolidone, naphthyridine, quinoline, quinoxaline, isoquinoline, phenanthroline and the like may be mentioned as examples of the heterocycle.

According to the present invention alkyl groups having 1 to 20 carbon atoms are preferred, such as methyl, ethyl, n-propyl, isopropyl, n-butyl, 2-butyl, tert.butyl, n-pentyl, n-hexyl, n-decyl, n-undecyl and n-dodecyl groups. Cycloalkyl groups preferably contain 3 to 20 carbon atoms and cyclopropyl, cyclobutyl, cyclohexyl, cycloheptyl, cyclooctyl, cyclononyl and cyclodecyl may be mentioned as examples. Also bicyclic and tricyclic groups may be used. Furthermore, aryl groups having 6 to 20 carbon atoms, such as phenyl, naphthyl and anthracenyl groups are preferred. At least one hydrogen atom of an alkyl group can be replaced by an aryl group in alkaryl groups. As examples for alkaryl groups ethylphenyl groups, propylphenyl groups and ethylnaphthyl groups may be mentioned. Heteroaryl groups preferably contain 2 to 15 carbon atoms and one or more heteroatoms independently selected from O, N and S. Furanyl groups, pyrazolyl groups, pyrazinyl groups, pyrazolyl groups, pyrrolyl groups, thienyl groups, triazolyl groups, pyridinyl groups, pyrimidyl groups, oxazolinyl groups, quinolinyl groups and isoquinolinyl groups and similar groups may be mentioned as examples. Each group may be unsubstituted or have one or more substituents independently selected from the group comprising halogen atoms (F, Cl, Br, I), alkyl, haloalkyl, cycloalkyl, aryl, nitro, cyano, hydroxyl, thiol, sulfonic acid, carboxylic acid, amino, alkylamino, dialkylamino and the like.

Furthermore, the polymers may also have cationic groups in the main chain, such as with ionenes. In this case, the cationic groups may be selected from the following:

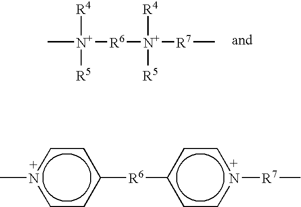

wherein
R⁴ and R⁵ may be the same or different from each other and are defined as above, and
R⁶ and R⁷ may be the same or different from each other and are optionally substituted bivalent linear, branched or cyclic alkyl, alkaryl or aryl groups, allyl, vinyl or benzyl groups which may optionally further contain one or more heteroatom containing groups, such as ester groups, ether groups, amide groups, urea groups, urethane groups, carbonate groups, anhydride groups and imide groups, and the like.

The cationic groups may be present in each repetitive unit or in lower proportions of the repetitive units only. Preferably cationic groups are contained in a proportion of 5-80% of the repetitive units, preferably 15-60% of the repetitive units.

Preferred polymers are poly(2-vinylpyridine), poly(4-vinylpyridine), poly(2-aminoethyl)acrylate, and poly(2-aminoethyl)methacrylate which are quaternized with linear, branched or cyclic alkyl, allyl, vinyl or benzyl groups, wherein the degree of quaternization amounts to 5-80%, preferably 15-60%.

The charge compensation of the cationic groups in the polymer is ensured by anions. According to the present invention, halogen ions as well as low nucleophilic and non-nucleophilic anions are preferably used. Examples of such anions comprise F⁻, Cl⁻, Br⁻, I⁻, BF₄⁻, PF₆⁻, AsF₆⁻, ClO₄⁻, CF₃SO₃⁻, (CF₃SO₂)₃C⁻ and (CF₃SO₂)₂N⁻ and the like, with CF₃SO₃⁻ and (CF₃SO₂)₂N⁻ being preferred. A particularly preferred anion is CF₃SO₃⁻.

The lithium salt component contained in the polymer electrolyte according to the present invention is a lithium salt or a mixture of several lithium salts. LiBF₄, LiPF₆, LiAsF₆, LiClO₄, LiCF₃SO₃, Li(CF₃SO₂)₃C, Li(CF₃SO₂)₂N and the like may be mentioned as examples for lithium salts suitable for the present invention. Li(CF₃SO₂)₂N is preferred.

For obtaining the polymer electrolyte according to the present invention, the lithium salt component is added to the polymer in an amount of 0.1 to 20% by weight, preferably 2.5 to 10% by weight and more preferably 4 to 6% by weight, based on the weight of the polymer as 100% by weight. In particularly preferred embodiments, the lithium salt component is added in an amount of about 5% by weight.

Polymer electrolytes consisting of such cationic polymers with Li⁺ (CF₃SO₂)₂N⁻ (LiTFSI, lithium bis(trifluoromethylsulfonyl)imide) exhibit conductivities above 10⁻⁴ S/cm at room temperature without the requirement of adding a plasticizer, a solvent or another additive.

The polymer electrolytes according to the present invention may further contain one or more functional additives. Such functional additives may positively influence various properties of the polymer electrolytes according to the present invention. For example, functional additives may serve to improve the adhesion to the electrodes, to form a passivation layer, to improve this formation, for flame retardancy, to improve the deposition of Li metal at the electrodes, to improve the processability of the polymer electrolytes according to the present invention and/or to improve the mechanical properties of the polymer electrolytes according to the present invention.

According to another aspect of the present invention, the polymer electrolytes according to the present invention may be used for the production of an electrochemical device, in particular a battery or a secondary battery and preferably a lithium metal polymer battery, a lithium polymer battery or a lithium ion battery.

Furthermore, the present invention provides electrochemical devices, in particular batteries and secondary batteries and preferably lithium metal polymer batteries, lithium polymer batteries and lithium ion batteries which comprise the polymer electrolytes according to the present invention.

In a further aspect of the present invention, the present invention provides a method for improving the conductivity of polymer electrolytes.

The promoting effect with respect to the dissociation of the Li salts is not limited to the use of ionic interactions between cationic groups contained in the polymer component and anionic groups contained in the lithium salt component. According to the present invention, the dissociation of the salts contained in the lithium salt component can also be enhanced by other stabilizing interactions of the polymer component with the anions contained in the lithium salt component and the ion conductivity of polymer electrolytes can be improved in that way. For this purpose, in particular hydrophobic interactions of the polymer component with the sterically demanding anions of the lithium salt component, charge-dipole interactions between the negative charges of the anions of the lithium salts and polar groups in the polymers used, supramolecular interactions between the anions and the polymers or a complexation of the anion by groups present in the polymers and similar interactions are possible.

### EXAMPLES

In the following the present invention is further explained with reference to examples. The examples mentioned serve to illustrate the invention and shall not be construed as limiting the invention. Further embodiments of the present invention are easily apparent for the person skilled in the art. Unless specified otherwise, percentages refer to the molar amount (mol-%).

In the examples, commercially available polymers (poly(4-vinylpyridine) from Sigma Aldrich (trade name Reilline) and poly(2-dimethyl(aminoethyl)methacrylate from Polysciences Europe) were used as starting polymers for the quaternization.

### Example 1

### Production of Poly-(4-vinylpyridine)-co-(4-vinyl-N-methylpyridinium trifluoromethanesulfonate)

43.7 g poly(4-vinylpyridine) (0.416 mol on the basis of monomeric 4-vinylpyridine) and 350 ml unaqueous dimethylformamide are charged into a 1000 ml 2-necked flask equipped with a blade stirrer and a dropping funnel. 75.0 g trifluoromethane sulfonic acid methyl ester (0.457 mol) are added dropwise to the solution at room temperature within 45 minutes. The reaction mixture is stirred for 16 h at room temperature and subsequently poured into 3 l dichloromethane to precipitate the polymer as a solid.

The separated polymer flakes are transferred into a Soxhlet extractor and extracted with diethylether for at least 48 h. Subsequently, the polymer is dried at a temperature of 100° C. and a pressure of 10⁻² to 10⁻³ mbar until weight constancy is reached. 78 g of a copolymer, the repetitive units of which consist of about 55 mol-% poly(4-vinyl-N-methylpyridinium trifluoromethanesulfonate), are obtained. The copolymer obtained exhibits a glass transition range of 150 to 160° C. The addition of 5 percent by weight of lithium bis(trifluoromethylsulfonyl)imide lowers the glass transition range to 130 to 140° C.

A film made of a mixture of the polymer with LiTFSI (molar ratio repetitive units: Li=30:1) exhibits an ion conductivity of 1·10⁻⁴ S/cm at room temperature.

### Example 2

### Production of Poly-(4-vinylpyridine)-co-(4-vinyl-N-undecylpyridinium trifluoromethanesulfonate)

A solution of 80.6 g poly(4-vinylpyridin) (0.762 mol on the basis of monomeric 4-vinylpyridine) and 300 ml unaqueous dimethylformamide is prepared in the apparatus described in Example 1. 96.4 g trifluoromethane sulfonic acid undecyl ester (0.32 mol) are added dropwise at room temperature within about 1 hour. The reaction mixture is stirred for a further 48 hours and subsequently poured into 5 l diethylether to precipitate the polymer as a solid. The further processing of the material is performed analogously to the procedure described in Example 1.114 g of a copolymer, the repetitive units of which consist of about 30 mol-% poly(4-vinyl-N-undecylpyridinium trifluoromethanesulfonate), are obtained.

The copolymer exhibits a glass transition range of 90 to 110° C. Addition of 5 percent by weight lithium bis(trifluoromethylsulfonyl)imide lowers the glass transition range to about 90 to 100° C.

A film made of a mixture of this polymer with LiTFSI (molar ratio repetitive units: Li=30:1) exhibits an ion conductivity of 3.5·10⁻⁴ S/cm at room temperature.

### Example 3

### Production of poly-(2-dimethylaminoethyl methacrylate)-co-(2-trimethylammoniumethyl methacrylate trifluoromethanesulfonate)

In the apparatus described in Example 1, a solution of 81.0 g poly(2-dimethylaminoethyl methacrylate) (0.515 mol on the basis of monomeric 2-dimethyl-aminoethyl methacrylate) and 200 ml unaqueous dimethylformamide is prepared. 92.9 g trifluoromethane sulfonic acid methyl ester (0.566 mol) are added dropwise at room temperature within about 3 hours. The reaction mixture is stirred for a further 48 hours and subsequently poured into 7 l dichloromethane to precipitate the polymer as a solid. The further processing of the material is performed analogously to the procedure described in Example 1.141 g of a copolymer, the repetitive units of which consist of about 80 mol-% of poly-(2-trimethylammoniumethyl methacrylate trifluoromethanesulfonate), are obtained.

The copolymer exhibits a glass transition range of 150 to 160° C. Addition of 5 percent by weight lithium bis(trifluoromethylsulfonyl)imide lowers the glass transition range to 135 to 145° C.

A film made of a mixture of this polymer with LiTFSI (molar ratio repetitive units: Li=30:1) exhibits an ion conductivity of 1.5·10⁻⁴ S/cm at room temperature.

### Example 4

### Production of Poly-(2-dimethylaminoethyl methacrylate)-co-(2-dimethylundecylammoniumethyl methacrylate trifluoromethanesulfonate)

A solution of 178.8 g poly(2-dimethylaminoethyl methacrylate) (1.13 mol on the basis of monomeric 2-dimethylaminoethyl methacrylate) and 400 ml unaqueous dimethylformamide is prepared in the apparatus described in Example 1. 96.0 g trifluoromethane sulfonic acid undecyl ester (0.315 mol) is added dropwise at room temperature within about 3 hours. The reaction mixture is stirred for further 48 hours and subsequently poured into 8 l diethylether to precipitate the polymer as a solid.

The further processing of the material is performed analogously to the procedure described in Example 1.193 g of a copolymer, the repetitive units of which consist of about 32 mol-% of poly-(2-dimethylundecylammoniumethyl methacrylate trifluoromethanesulfonate), are obtained.

The copolymer exhibits a glass transition range of 65 to 80° C. Addition of 5 percent by weight lithium bis(trifluoromethylsulfonyl)imide lowers the glass transition range to 55 to 65° C.

A film made of a mixture of this polymer with LiTFSI (molar ratio repetitive units: Li=30:1) exhibits an ion conductivity of 5.5·10⁻⁴ S/cm at room temperature.

### Comparative Example 1

### Use of poly(ethylene oxide) in a polymer electrolyte

A film made of a mixture of poly(ethylene oxide) with LiClO₄ (molar ratio repetitive units: Li=8:1) exhibits an ion conductivity of 10⁻⁸ S/cm at 20° C.

### Comparative Example 2

### Use of Poly(Ethylene Oxide) with Propylene Carbonate as Plasticizer in a Polymer Electrolyte

A film made of a mixture of poly(ethylene oxide) after crosslinking with 50% by weight propylene carbonate as plasticizer with LiClO₄ (molar ratio repetitive units: Li=8:1) exhibits an ion conductivity of 8·10⁻⁴ S/cm at 20° C.

The examples and comparative examples clearly demonstrate that the polymer electrolytes according to the present invention exhibit ion conductivities which can only be achieved by conventional systems on the basis of poly(ethylene oxide) after adding plasticizers and by the use of a significantly higher amount of Li salt.

What is claimed is:

1. Polymer electrolyte comprising a lithium salt component and a polymer component, wherein the polymer component comprises at least one polymer compound, the repetitive units of which contain at least partially groups which interact with the anions of the lithium salt component such that the dissociation of the lithium salt is enhanced, wherein these groups are an element of the polymer main chain and/or an element of side chains attached to the polymer main chain of the polymer compound.

2. Polymer electrolyte according to claim 1, wherein the groups enhancing the dissociation of the lithium salt are cationic groups.

3. Polymer electrolyte according to claim 1, wherein the polymer main chain is selected from the group comprising polystyrenes, polyacrylates, polymethacrylates, polyolefines, polyvinyl compounds, polyethers, polyepichlorhydrin, poly(tetrahydrofuran), polydienes, polyesters, polyamides, polyimides, poly(aryletherketone)s, poly(arylethersulfone)s, poly(arylene oxide)s, polyarylenes, polycarbonates, polyanhydrides, polyurethanes, polyureas, binary, ternary, quaternary and higher, statistic and alternating copolymers, block copolymers and graft copolymers on the basis of these polymers, blends of at least two of these polymers and branched, hyperbranched and crosslinked polymers on the basis of such polymers.

4. Polymer electrolyte according to claim 1, wherein the polymer component is a microphase separated material comprising at least one polymer compound selected from the group comprising polystyrenes, polyacrylates, polymethacrylates, polyolefines, polyvinyl compounds, polyethers, polyepichlorhydrin, poly(tetrahydrofuran), polydienes, polyesters, polyamides, polyimides, poly(aryletherketone)s, poly(arylethersulfone)s, poly(arylene oxide)s, polyarylenes, polycarbonates, polyanhydrides, polyurethanes, polyureas, binary, ternary, quaternary and higher, statistic and alternating copolymers, block copolymers and graft copolymers on the basis of these polymers, blends of at least two of these polymers and branched, hyperbranched and crosslinked polymers on the basis of such polymers, wherein the cationic groups are present in at least one of the separated microphases.

5. Polymer electrolyte according to claim 2, wherein the cationic groups are selected from the group comprising linear, cyclic and branched aliphatic, aromatic and aromatic-aliphatic ammonium groups, hydrazinium groups, phosphonium groups, sulfonium groups, iodonium groups and positively charged metal complexes.

6. Polymer electrolyte according to claim 5, wherein the cationic groups are linear, cyclic or branched aliphatic, aromatic-aliphatic or aromatic ammonium groups.

7. Polymer electrolyte according to claim 6, wherein the cationic groups are present in side chains of the polymer and are selected from the following: 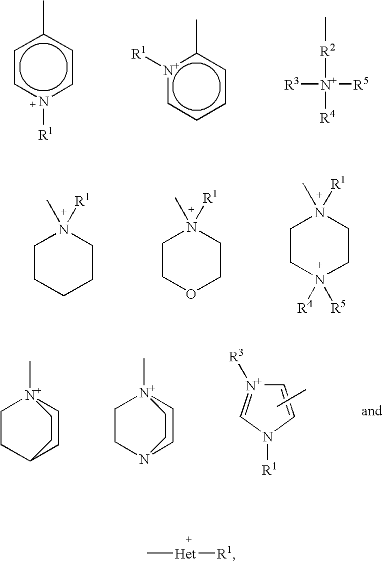
wherein
R¹, R³, R⁴ and R⁵ are independently optionally substituted alkyl, branched alkyl, cycloalkyl, vinyl, allyl, benzyl, aryl, heteroaryl or alkaryl groups,
R² is a single bond or an optionally substituted bifunctional alkyl, aryl, heteroaryl or alkaryl group which may further optionally contain one or more heteroatom containing groups selected from the group comprising ester groups, ether groups, amide groups, urea groups, urethane groups, carbonate groups, anhydride groups and imide groups, and
Het is a nitrogen containing, optionally substituted aromatic or non-aromatic heterocyle having one or more nitrogen atoms selected from the group comprising pyridine, pyrazine, pyrazole, triazole, pyrrole, oxazoline, pyrrolidine, naphthyridine, quinoline, quinoxaline, isoquinoline and phenanthroline.

8. Polymer electrolyte according to claim 1, wherein the polymer compound is selected from the group comprising poly(2-vinylpyridine), poly(4-vinylpyridine), poly(2-aminoethyl)acrylate and poly(2-aminoethyl)methacrylate and the nitrogen atoms contained in the polymer compound are partially quaternized with linear, branched or cyclic alkyl, allyl, vinyl or benzyl groups, wherein the degree of quaternization is 5-80%.

9. Polymer electrolyte according to claim 8, wherein the degree of quaternization is 15-60%.

10. Polymer electrolyte according to claim 6, wherein the cationic groups are present in the polymer main chain and selected from the following: 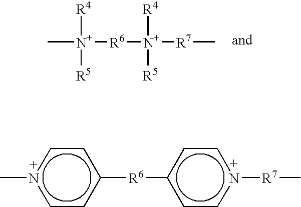
wherein
R⁴ and R⁵ may be the same or different from each other and are defined as in claim 6, and
R⁶ and R⁷ may be the same or different from each other and are optionally substituted bivalent linear, branched or cyclic alkyl, alkaryl or aryl groups, allyl, vinyl or benzyl groups which may optionally further contain one or more heteroatom containing groups, selected from the group comprising ester groups, ether groups, amide groups, urea groups, urethane groups, carbonate groups, anhydride groups and imide groups.

11. Polymer electrolyte according to claim 2, wherein the positive charges of the cationic groups are compensated by anions selected from the group comprising F⁻, Cl⁻, Br⁻, l⁻, BF₄⁻, PF₆⁻, AsF₆⁻, ClO₄⁻, CF₃SO₃⁻, (CF₃SO₂)₃C⁻ and (CF₃SO₂)₂N⁻.

12. Polymer electrolyte according to claim 11, wherein the positive charges of the cationic groups are compensated by CF₃SO₃⁻ anions.

13. Polymer electrolyte according to claim 1, wherein the lithium salt component is selected from the group comprising LiBF₄, LiPF₆, LiAsF₆, LiClO₄, LiCF₃SO₃, Li(CF₃SO₂)₃C, Li(CF₃SO₂)₂N and mixtures of at least two thereof.

14. Polymer electrolyte according to claim 1, wherein the polymer electrolyte has a glass transition temperature above room temperature.

15. Polymer electrolyte according to claim 14, wherein the glass transition temperature of the polymer electrolyte is within the range of 50° C. to 150° C.

16. Polymer electrolyte according to claim 1, wherein the polymer electrolyte has an ion conductivity at room temperature of at least 10⁻⁴ S/cm without addition of a plasticizer or a solvent.

17. Polymer electrolyte according to claim 1, which further comprises functional additives for improving the adherence to the electrodes, for forming a passivation layer, for improving this formation, for flame retardancy, for improving the deposition of Li metal at the electrodes, for improving the processability thereof and/or for improving the mechanical properties thereof.

18. Use of a polymer electrolyte according to claim 1 for the production of an electrochemical device.

19. Use of a polymer electrolyte according to claim 18, wherein the electrochemical device is a battery or a secondary battery.

20. Use of a polymer electrolyte according to claim 19, wherein the electrochemical device is a lithium ion battery, a lithium polymer battery or a lithium metal polymer battery.

21. Electrochemical device, comprising a polymer electrolyte according to claim 1.

22. Electrochemical device according to claim 21, wherein the electrochemical device is a battery or a secondary battery.

23. Electrochemical device according to claim 22, wherein the electrochemical device is a lithium ion battery, a lithium polymer battery or a lithium metal polymer battery.

24. Method for increasing the ion conductivity of a polymer electrolyte comprising a lithium salt component and a polymer component, wherein the increase in ion conductivity is effected by stabilizing interaction of the polymer component with the anions contained in the lithium salt component.

25. Method according to claim 24, wherein the stabilizing interaction is an ionic interaction between the cationic groups contained in the polymer component and the anions contained in the lithium salt component.

26. Method according to claim 24, wherein the stabilizing interaction is a hydrophobic interaction, a charge-dipole interaction, a supramolecular interaction or a complex formation between the polymer component and the anions contained in the lithium salt component.
